(19) United States
(12) Patent Application Publication
(10) Pub. No.: US 2026/0163441 A1
(43) Pub. Date: Jun. 11, 2026

(54) SWITCHING RING FOR A MULTIPHASE ELECTRIC MOTOR

(71) Applicant: iwis mobility systems GmbH & Co. KG, München (DE)

(72) Inventors: Franz STIGLMAIER, München (DE); Ulrich LINDNER, München (DE)

(21) Appl. No.: 19/409,618

(22) Filed: Dec. 4, 2025

(30) Foreign Application Priority Data
Dec. 11, 2024 (DE) 102024137110.2

(51) Int. Cl. H02K 5/22; H02K 3/04; H02K 15/062

(52) U.S. Cl. CPC H02K 5/22; H02K 3/04; H02K 15/062

(57) ABSTRACT

A switching ring for a multiphase electric motor includes at least two coils per phase for generating magnetic fields, wherein the switching ring includes phase conductor tracks of the busbar type for contacting the coils, and the conductor tracks include phase conductor tracks and each of the phase conductor tracks contacts the coils of one phase, and the switching ring includes a holding device and the phase conductor tracks are received, positioned, and insulated from one another in the holding device, and the switching ring is pluggable to the stator of the electric motor for contacting the coils. The phase conductor tracks of the switching ring are designed as identical parts.

### CROSS-REFERENCE TO RELATED APPLICATION

This application claims priority to foreign German patent application No. DE 102024137110.2, filed on Dec. 11, 2024, the disclosure of which is incorporated by reference in its entirety.

### FIELD OF THE INVENTION

The present invention relates to a switching ring for a multiphase electric motor according to the preamble of independent claim 1.

### BACKGROUND

Such a switching ring for a multiphase electric motor, wherein the electric motor comprises at least two coils per phase for generating magnetic fields, comprises conductor tracks of the busbar type for contacting the coils, wherein the conductor tracks comprise phase conductor tracks and each of the phase conductor tracks is configured to contact the coils of one phase, and wherein the phase conductor tracks are positioned relative to each other and insulated from each other, and wherein the switching ring for contacting the coils is pluggable onto the stator of the electric motor.

Generic switching rings are used to connect the coils of an electric motor in order to supply them with power and control them accordingly.

A wide range of requirements are placed on generic switching rings. For example, switching rings must ensure safe and permanent contact with the coils. In addition, the design of the switching ring and the contact process between the switching ring and the coils should be kept as simple as possible.

EP 2 212 985 B1 discloses a brushless electric motor with a switching ring. The electric motor comprises a housing in which a rotor and a stator equipped with coils are arranged. The stator is connected to a switching ring, which comprises phase conductor tracks that supply the coils of the stator with current and control the coils. The phase conductor tracks are designed in the manner of a busbar and are held and positioned in a holding device. The phase conductor tracks are essentially designed as circular ring sections with different diameters and are arranged concentrically to one another. The phase conductor tracks comprise contact ends for contacting the coils of the electric motor, which extend in the axial direction relative to the axis of the electric motor. In addition, the phase conductor tracks comprise connection tabs that extend in the radial direction relative to the axis of the electric motor. The switching ring is pluggable onto the stator of the electric motor.

### SUMMARY OF THE INVENTION

The objective of the present invention is to provide a switching ring for multiphase electric motors that is simpler in design and therefore easier to manufacture.

The task is solved by the features of independent claim 1.

Accordingly, a solution to the task in accordance with the invention is provided when the phase conductor tracks of the switching ring are designed as identical parts.

Advantageous embodiments of the present invention are part of the dependent claims.

According to an advantageous embodiment of the present invention, the phase conductor tracks comprise a base section that is essentially designed as a circular ring section, and the phase conductor tracks comprise contact ends, wherein the contact ends extend in the axial direction from the base section and are configured to be brought into contact with phase wire ends of the coils, and wherein the phase conductor tracks each comprise one or more connection tabs for contacting with a phase controller.

The fact that the base section of the phase conductor tracks is essentially designed as a circular ring section means, in the case of the present invention, that the base section fits as a structure between two circular arcs with different radii and the same direction of curvature, wherein the structure may of course comprise recesses extending from one of the two circular arcs or arranged between the circular arcs. Accordingly, the circumferential boundary of the base section is not limited to the exact shape of a geometric circular ring, in which the edges, which are conceived as straight lines, meet at the center of a circle, but can be freely designed within the framework of the structural design of the base section.

In the context of the present invention, the circular ring section is also understood to mean a complete circular ring. Consequently, it is also conceivable that the base section of the phase conductor tracks forms a continuous circular ring.

The phase conductor tracks comprise contact ends for contacting the coils, with each contact end being assigned to the output or input of a coil. The contact ends extend in the axial direction from the base section of the phase conductor tracks, which means that they are arranged parallel to the circular arc axis of the base section. Advantageously, the contact ends of a phase conductor track are geometrically identical. However, it is also conceivable that the contact ends of a phase conductor track are geometrically different. Depending on requirements, the contact ends can be arranged radially inside the base section or on the outside of the base section. It is also conceivable, however, that the contact ends are provided at the circumferential boundary of the base section. If the manufacturing process of the phase conductor tracks allows it, the contact ends can also be arranged in the middle of the base section, i.e., at a distance from each end of the base section.

The phase conductor tracks have a connection tab for connection to the power supply and control of the coils by means of a corresponding phase controller. Advantageously, the connection tabs also extend in the axial direction to the base section. It is also advantageous if the connection tabs are arranged on the inner or outer boundary of the base section in the radial direction and extend away from the base section in the opposite direction to the contact ends.

According to a further advantageous embodiment of the present invention, the switching ring comprises a neutral point conductor track that is configured to connect coils to each other to implement a star connection, wherein the neutral point conductor track comprises a base section that is essentially designed as a circular ring section, and wherein the neutral point conductor track comprises contact ends that extend in the axial direction from the base section and are configured to be brought into contact with the neutral point wire ends of the coils.

The base section of the neutral point conductor track can also be designed as a full ring. The neutral point conductor track comprises contact ends for connecting the coils, with one contact end assigned to each coil. Advantageously, the contact ends of the neutral point conductor track are geometrically identical. However, it is also conceivable that the contact ends of the neutral point conductor track are geometrically different. The contact ends of the neutral point conductor track extend in the axial direction from the base section of the neutral point conductor track, which means that they are arranged parallel to the arc axis of the base section of the neutral point conductor track. Depending on requirements, the contact ends can be arranged radially inside the base section of the neutral point conductor track or on the outside of the base section. If the manufacturing process of the phase conductor tracks allows it, the contact ends can also be arranged in the middle of the base section, i.e., at a distance from each end of the base section.

In one embodiment, the switching ring comprises exactly one neutral point conductor track, wherein the neutral point conductor track has exactly one contact end per coil in order to connect all coils to each other.

According to a particularly advantageous embodiment of the present invention, the base section of the phase conductor tracks has a cross-sectional area, wherein the cross-sectional area comprises a height and a width, wherein the height of the cross-sectional area is defined in the axial direction of the circular ring section and the width of the cross-sectional area is defined in the radial direction of the circular ring section, wherein the ratio of the height to the width is less than 1, preferably less than 0.5, and particularly preferably at most 0.2.

The design of the base section of the phase conductor tracks with a height-to-width ratio of less than 0.2 allows for a particularly compact and space-saving construction of the switching ring. A ratio of height to width that is as small as possible is advantageous, wherein aspects of the stability of the phase conductor track and the design of the cross-sectional area for effective current transmission must be taken into account in the design. Consequently, the cross-sectional ratio cannot be infinitely small. Depending on the material, a cross-sectional ratio of 0.05 is considered a reasonable technical lower limit.

The flat design of the base section of the phase conductor tracks is particularly advantageous when the phase conductor tracks are arranged in an axially offset manner. This allows the switching ring to take up only minimal installation space, especially in the axial direction, and consequently also reduces the installation space required for the entire electric motor.

According to another advantageous embodiment of the present invention, the contact ends of the phase conductor tracks protrude radially beyond the base section and comprise fork-shaped elements, wherein the fork-shaped elements are configured to at least partially surround the phase wire ends of the coils and/or the contact ends of the neutral point conductor track protrude radially beyond the base section and comprise fork-shaped elements, wherein the fork-shaped elements are configured to at least partially surround the neutral point wire ends of the coils. In a conceivable variant, the contact ends of the phase conductor tracks do not comprise fork-shaped elements, but have an alternative geometry that allows them to surround the phase wire ends of the coils at least in sections.

The contact ends of the phase conductor tracks and/or the neutral point conductor tracks may protrude radially inward beyond the base section. However, it is advantageous if both the contact ends of the phase conductor tracks and the contact ends of the neutral point conductor tracks protrude radially outward beyond the base section. In order for the contact ends of the phase conductor tracks and the neutral point conductor track, which extend in the axial direction, to protrude radially beyond their respective base sections, the contact ends comprise a connecting section which connects the axial section of the contact ends to the base section of the conductor tracks and which extends at least partially in the radial direction.

The fork-shaped elements of the contact ends and the neutral point conductor track are configured to be brought into contact with the corresponding wire ends of the coils. Advantageously, the fork-shaped elements comprise a first fork body and a second fork body analogous to a fork, wherein the space between the first and second fork bodies is dimensioned to accommodate the wire ends of the coil, whereby the fork-shaped elements surround the wire end.

It is conceivable that the fork-shaped elements are designed in such a way that they can only partially accommodate and partially surround the wire ends of the coil. However, for secure and reliable contact, it is advantageous if the fork-shaped elements are designed in such a way that the wire ends can be completely surrounded. In this case, completely enclosed means that the wire ends, viewed in the radial direction of the wire, are completely enclosed on three sides by the fork-shaped elements. The distance between the first and second fork bodies is greater than the diameter of the coil wire ends to be accommodated, but no more than twice the diameter of the coil wire ends to be accommodated.

According to another advantageous embodiment of the present invention, the contact ends of the phase conductor tracks and the contact ends of the neutral point conductor track are axially moveable onto the corresponding wire ends of the coils relative to the motor axis, wherein the switching ring is essentially pluggable in the axial direction onto the stator, and wherein the plugging process is at least part of the contacting or a prerequisite for the contacting.

The switching ring and stator are aligned with each other in such a way that the plugging process is ideally carried out with the switching ring and stator coaxially aligned with each other and with an axial plugging movement. In this context, essentially axial means that the switching ring is pluggable on the stator even if there is an angular misalignment between the switching ring and the stator and/or an angular misalignment in the plugging direction. An offset of the axes of the switching ring and stator as well as of the insertion movement of up to 15°, preferably up to 10° and particularly preferably up to 5°, is permissible in this sense.

The particular advantage lies in the fact that the switching ring is pluggable to the stator in a single step and that the plugging process already comprises partial contacting, which makes installation particularly easy. To this end, it is necessary that the contact ends of the conductor tracks can also be moved axially onto the corresponding wire ends of the coils. Advantageously, the contact ends comprise fork-shaped elements that completely or partially surround the wire ends of the coils. However, other designs of the contact ends are also conceivable that allow axial sliding onto the wire ends of the coils.

If the switching ring is designed with axially offset phase conductor tracks, the identical design of the phase conductor tracks inevitably results in an axial offset at the contact ends, i.e., in the area where the coils are contacted. The axial offset can be compensated for, for example, by the arrangement of the coil wire ends, which then comprise the same axial offset to each other as the phase conductor tracks comprise to each other. Another option is to design the fork bodies of the fork-shaped elements of the contact ends and the space between the fork bodies so that the axial offset to the coil wire ends arranged on an axial plane is compensated and the coil wire ends can be at least partially surrounded.

The possibility of axially plugging the switching ring onto the stator also offers the advantage that the switching ring can be installed even if the stator is already installed in a housing that completely encloses it radially and possibly even protrudes axially beyond the stator.

It is conceivable that the contact ends of the conductor tracks and the wire ends of the coils are matched in such a way that complete contact is established during the plugging process. For this purpose, the contact ends could, for example, be designed in the manner of a terminal.

In another variant, the plugging process only results in partial contacting of the coils, in that sliding the contact ends onto the wire ends of the coils establishes contact between the contact ends and the wire ends that is insufficient for complete and secure contacting. In this case, a further contacting step may be provided to ensure complete contacting. For example, it may be provided that the contact ends are designed in a fork shape and that, after the plugging process, the fork bodies are pressed together in a further step to establish complete contact, thereby securely contacting the wire ends. Final welding, e.g., using welding pliers, is also possible.

According to another advantageous embodiment of the present invention, the circular arc axes of the base sections of the phase conductor tracks, which are designed as circular ring sections, are essentially coaxial with each other. In other words, all base sections of the conductor tracks lie within a circular ring whose width corresponds to the width of a base section. In this context, “essentially” means that manufacturing-related deviations in geometry can result in the circular arc axes not being exactly coaxial with each other, i.e., they may be parallel or even at an angle to each other, even though the phase conductor tracks are embodied as identical parts in accordance with the invention. Manufacturing-related deviations of the circular arc axes relative to each other are therefore also understood to be essentially coaxial with each other.

The coaxial arrangement of the base sections of the phase conductor tracks offers the advantage that the phase conductor tracks require very little installation space in the radial direction and the switching ring can be designed to be correspondingly compact and with reduced material costs.

According to a particularly advantageous embodiment of the present invention, the phase conductor tracks are arranged rotated about their circular arc axis and are arranged axially offset from one another and partially overlap in the circumferential direction.

The axially offset arrangement of the phase conductor tracks allows the phase conductor tracks to be arranged rotated about their circular arc axis in such a way that they overlap in the circumferential direction. This has the advantage that the phase conductor tracks can extend over a large angular range without necessarily increasing the space required for the switching ring.

A particularly compact design of the switching ring in the axial direction is achieved when the axial distance between the phase conductor tracks is particularly small, wherein the distance must be large enough to ensure reliable insulation of the phase conductor tracks from each other. In addition, the minimum distance is limited by a minimum requirement for the stability of the holding device itself in order to ensure economically viable manufacturability. The holding device can, for example, be manufactured using an injection molding process in which larger gradients in the wall thickness are avoided as far as possible.

Depending on the arrangement of the coils of the electric motor and the arrangement of the contact ends at the base section of the phase conductor tracks, very high degrees of overlap between the phase conductor tracks may be possible. If, for example, six coils are evenly distributed around the stator circumference and two opposite coils form one phase, three phase conductor tracks are required for contacting, the base sections of which extend over at least 180° each, provided that the contact ends do not protrude beyond the base section in the circumferential direction. In this case, two phase conductor tracks always overlap by approximately 120°, wherein all three conductor tracks overlap in a range of just under 60°.

According to a further particularly advantageous embodiment of the present invention, the neutral point conductor track is arranged axially offset from the phase conductor tracks, and the arc axis of the base section of the neutral point conductor track, which is designed as a circular ring section, is arranged essentially parallel to the arc axes of the base sections of the phase conductor tracks, and the base section of the neutral point conductor track is arranged, seen from the axial direction, at least partially overlapping the base sections of the phase conductor tracks, preferably overlapping by at least 50%.

In this context, “essentially parallel” means that an offset in the parallelism of the circular arc axes for manufacturing reasons is included.

An advantage is provided when the cross-sectional area of the neutral point conductor track comprises the same width as the cross-sectional area of the phase conductor tracks and the arc axis of the base section of the neutral point conductor track is arranged coaxially with the arc axes of the base sections of the phase conductor tracks. The axial offset of the neutral point conductor track relative to the phase conductor tracks then also allows the base sections of the conductor tracks to overlap completely when seen from the axial direction. This arrangement of the conductor tracks relative to each other contributes in particular to a compact design of the switching ring.

It is particularly advantageous if the cross-sectional area of the neutral point conductor track is also of the same height as the cross-sectional area of the phase conductor tracks, since this means that, for example, if the conductor tracks are made from sheet metal, the same raw material can be used to manufacture the conductor tracks, thereby significantly simplifying the production of the switching ring.

An advantageous embodiment further provides that the neutral point conductor track is received in the holding device, positioned, and insulated from the phase conductor tracks.

According to a further particularly advantageous embodiment of the present invention, the phase conductor tracks are elements manufactured using a punch-bending technique.

Theoretically, it would also be conceivable for the phase conductor tracks to be elements manufactured using a 3D printing process. However, the particular advantage of designing the phase conductor tracks as identical parts is particularly evident in their manufacture using a punch-bending technique.

As a punched-bending part, the phase conductor tracks, comprising the contact ends, the connection tabs, and the base section, are punched out of a sheet metal. As a result, the contact ends, the connection tabs, and the base section comprise the same material thickness. In a further step, which may also be part of the assembly of the switching ring, the contact ends and the connection tab are bent into the desired position relative to the base section. In a material-saving alternative, the connection tabs and the base sections can be punched out separately from a sheet metal and then joined together in the intended arrangement using a joining process.

It is also advantageous if the neutral point conductor track is an element manufactured using a punch-bending technique and comprises the same material thickness as the phase conductor tracks. Then it is possible to manufacture all conductor tracks from the same raw sheet metal.

According to another advantageous embodiment of the present invention, the switching ring comprises a holding device for positioning at least some of the conductor tracks relative to each other.

For a particularly compact embodiment of the switching ring, the holding device is essentially arc-shaped. In this case, essentially arc-shaped means that the holding device is a structure that can be delimited by two circular arcs with the same direction of curvature and different radii. A particularly simple and reliable design of the switching ring is achieved when the holding device is designed to position all conductor tracks relative to each other. It is also conceivable that the holding device also performs an insulating function and insulates the conductor tracks from each other.

In an advantageous embodiment, the holding device has axially offset receiving elements in the form of pockets for the conductor tracks, wherein the lowest and uppermost of said pockets each comprise two positioning pins which interact with corresponding positioning recesses in the conductor tracks. In order to position the conductor tracks not only in the radial plane but also to fix them in the axial direction, the positioning pins have a region whose circumference is larger than the diameter of the corresponding positioning recess to create a press fit. For easier assembly, the positioning pins also comprise flexible ribs and are tapered. The receiving elements, which are designed as pockets and are not located axially at the bottom or top, are closed axially from above and bottom so that the conductor tracks are inserted into the pockets from the radial direction and are positioned by the corresponding geometry of the pockets. Another option is to position the conductor tracks relative to the holding device by means of corresponding stops.

According to a further advantageous embodiment of the present invention, the switching ring comprises sub-segments for generating redundancy for fail-safe operation of the electric motor, wherein each sub-segment comprises conductor tracks of the busbar type for contacting the coils, the conductor tracks comprising phase conductor tracks, and each of the phase conductor tracks being configured to contact the coils of one phase, and wherein the phase conductor tracks are positioned relative to each other and insulated from each other, and wherein the sub-segments for contacting the coils can be pluggable onto the stator of the electric motor, and wherein the phase conductor tracks of the sub-segments are designed as identical parts. The sub-segments can be connected to each other. The connection can then preferably be made by means of elastic connecting elements.

The switching ring can comprise two sub-segments, for example, wherein each of the sub-segments is designed as a half switching ring, so to speak. Advantageously, the sub-segments are not arranged axially offset from each other, but are arranged in the same axial plane relative to the axis of the electric motor. A certain number of coils are assigned to each sub-segment. In an exemplary embodiment, six coils are assigned to each sub-segment, wherein two coils form one phase. The electric motor then comprises a total of 12 coils, wherein six coils are arranged over a first angular range of up to 180° and are assigned to one of the sub-segments, and six coils are arranged over a second angular range of up to 180° and are assigned to the other sub-segment. The 12 coils are preferably arranged regularly around the circumference. In accordance with the arrangement of the coils assigned to the respective sub-segment, the respective sub-segments also extend over a specific angular range. The two sub-segments can be connected to each other via connecting elements. It is conceivable that the connecting elements are elastic.

In the embodiment described, the six coils are each assigned to one of the two sub-segments of the switching ring in such a way that six coils in combination with one sub-segment are sufficient to drive the electric motor. In other words, the electric motor with 12 coils comprises two three-phase half motors, each with six coils, wherein each half motor is assigned a sub-segment for contacting and control. The electric motor can therefore be operated in normal mode with all 12 coils and both sub-segments, for example. Another advantage of the described design is that the electric motor can also be operated in partial mode or emergency mode, either intentionally or because one of the subsystems consisting of a sub-segment and the coils assigned to the sub-segment is not operational. The described design therefore not only enables a particularly compact design of the switching ring, but also ensures fail-safe operation of the electric motor due to its redundant embodiment.

The redundancy of the electric motor is based on the use of two sub-segments. It is not necessary for the sub-segments to comprise identical parts in order to create redundancy.

The number of sub-segments is not limited to two. Depending on the requirements and design of the electric motor, three or more sub-segments are also conceivable.

In a further advantageous embodiment of the present invention, the conductor tracks of a sub-segment comprise a neutral point conductor track and the neutral point conductor tracks of the sub-segments are designed as identical parts.

It is particularly advantageous if all sub-segments are constructed identically, i.e., not only the phase conductor tracks are designed as identical parts, but also the neutral point conductor tracks and the holding devices. The holding device also receives the neutral point conductor track, which connects coils to each other to implement a star connection, positions them, and insulates them from the phase conductor tracks.

The fact that the sub-segments of the switching ring are identical not only greatly simplifies the manufacture of the switching ring, but also makes it very cost-effective.

The present invention also comprises a multiphase electric motor with a rotor, a stator, and coils for generating magnetic fields, wherein the electric motor comprises a switching ring according to one of the embodiments described above.

Another advantage is that all coils can be wound independently and individually; the interconnection is then made by plugging the switching ring into place. This is rotation-independent, thus ruling out incorrect interconnection.

The switching ring must be secured with centering devices and locking hooks after installation. A PokaYoke feature is also included to prevent rotation. When using insulation displacement connections, centering devices and locking hooks are not necessary, as these are secured by barbs in the wire pockets, which prevent the ring from moving.

Furthermore, a method for manufacturing a switching ring, in particular a switching ring according to one of the previously described embodiments, is claimed, comprising the following method steps:
Equipping a prefabricated plastic part with conductor tracks, wherein the prefabricated plastic part is designed in such a way that it positions the conductor tracks in relation to each other in the position intended for the finished switching ring,
Overmolding the assembled prefabricated plastic part with plastic in such a way that the conductor tracks are overmolded as completely as possible, except for connection areas, in particular the contact ends and connection tabs, for connecting the coils.

Advantageously, the prefabricated plastic part is designed in such a way that it not only positions the conductor tracks in relation to each other, but also insulates them from each other. The insulation of the base sections of the conductor tracks from the environment is achieved by overmolding the plastic part. By overmolding the plastic part and the base sections of the conductor tracks, a housing for the switching ring can be formed, wherein additional functional features can be created on the housing through the overmolding process. It is conceivable, for example, that all sub-segments of the switching ring are overmolded in a single process step, thereby creating the connecting elements that join the sub-segments together.

In a preferred embodiment of the method, the contact ends and/or the connection tabs of the conductor tracks are only brought into their intended shape, either completely or at least partially, after the prefabricated plastic part has been assembled with the conductor tracks, by means of a bending process. This can significantly simplify the assembly of the plastic part. It is conceivable, for example, that the contact ends and/or the connection tabs of the conductor tracks are partially bent after assembly and that the final shaping only takes place after the plastic part has been overmolded. However, it may also be advantageous to bend the contact ends and/or connection tabs of the conductor tracks in a single process step after overmolding.

In the following embodiments, identical parts are designated by identical reference symbols. If a figure contains reference symbols that are not discussed in detail in the corresponding figure description, reference is made to preceding or subsequent figure descriptions.

The following describes in more detail an embodiment of a switching ring and an electric motor according to the invention with reference to drawings.

### BRIEF DESCRIPTION OF THE DRAWINGS

FIG. 1: Perspective view of an electric motor with the switching ring according to the invention, viewed from above.

FIG. 2: Perspective view of the electric motor from FIG. 1 without housing.

FIG. 3: Perspective view of the switching ring according to the invention from FIG. 1.

FIG. 4: Perspective view of the conductor tracks and coils of the electric motor from FIG. 1,

FIG. 5: Perspective view of the phase conductor tracks of the switching ring according to the invention from FIG. 1,

FIG. 6: Perspective view of the neutral point conductor tracks of the switching ring according to the invention from FIG. 1,

FIG. 7: Perspective view of the prefabricated plastic part of the switching ring from FIG. 1.

### DETAILED DESCRIPTION

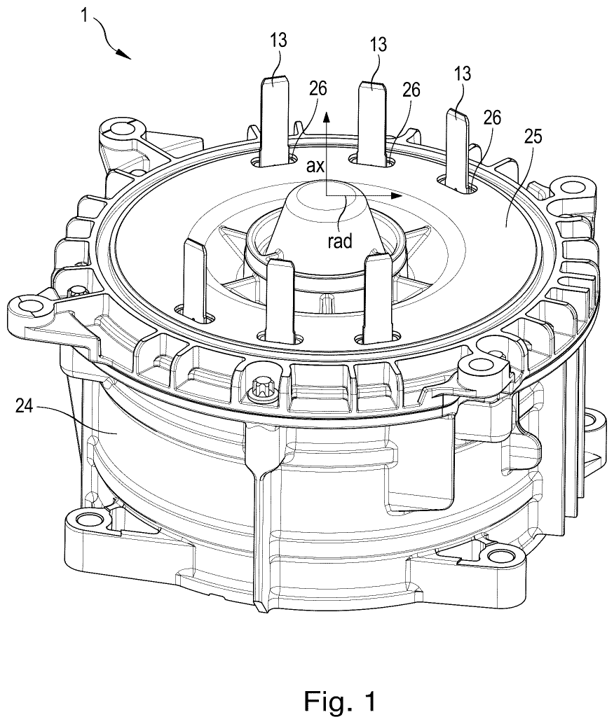

FIG. 1 shows an electric motor 1 according to the invention with a housing 24 and a bearing shield 25. Six connection tabs 13 for controlling the electric motor 1 protrude through lead-throughs 26 in the bearing shield 25. The directional arrow ax indicates the axis of the electric motor 1, while the directional arrow rad indicates the corresponding radial direction.

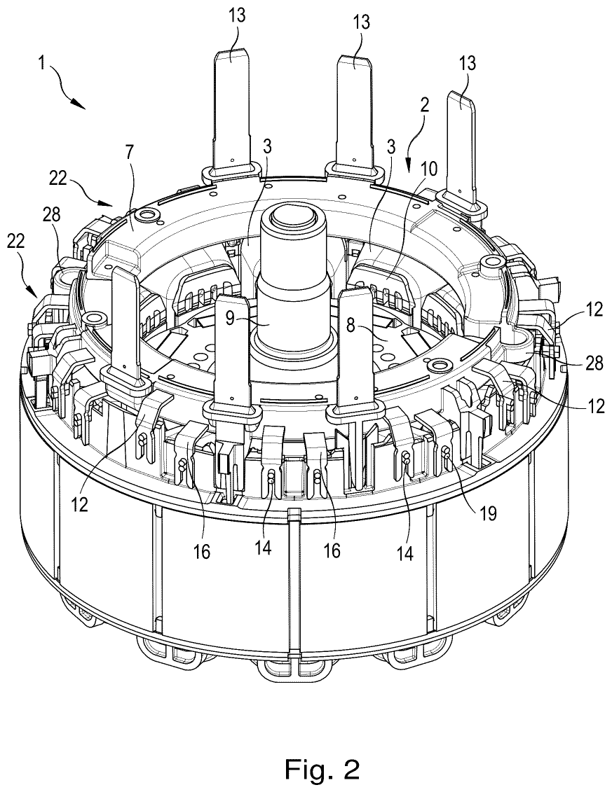

FIG. 2 shows the electric motor 1 according to the invention from FIG. 1 and a switching ring 2 according to the invention without the housing 24 and the bearing shield 25. The switching ring 2 comprises two sub-segments 22, which are connected to each other by two elastically designed connecting elements 28. The rotor 8 with rotor shaft 9 and the stator 10 wrapped with coils 3 can be seen.

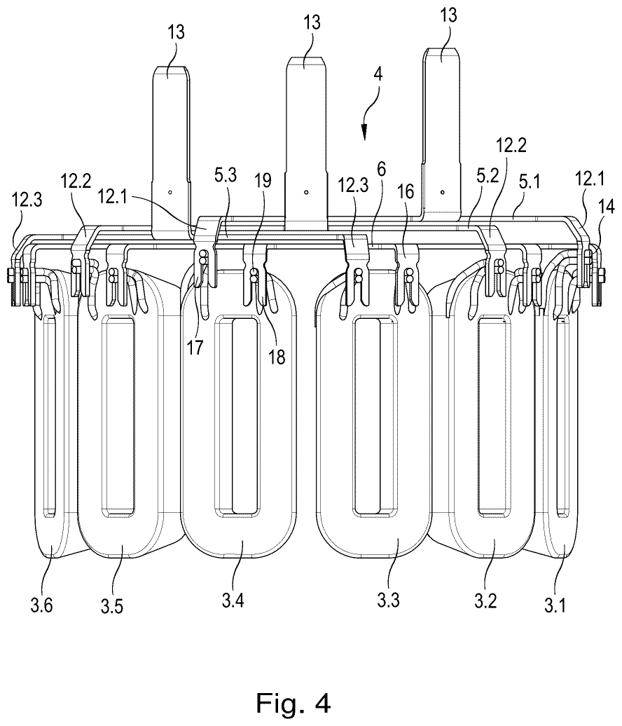

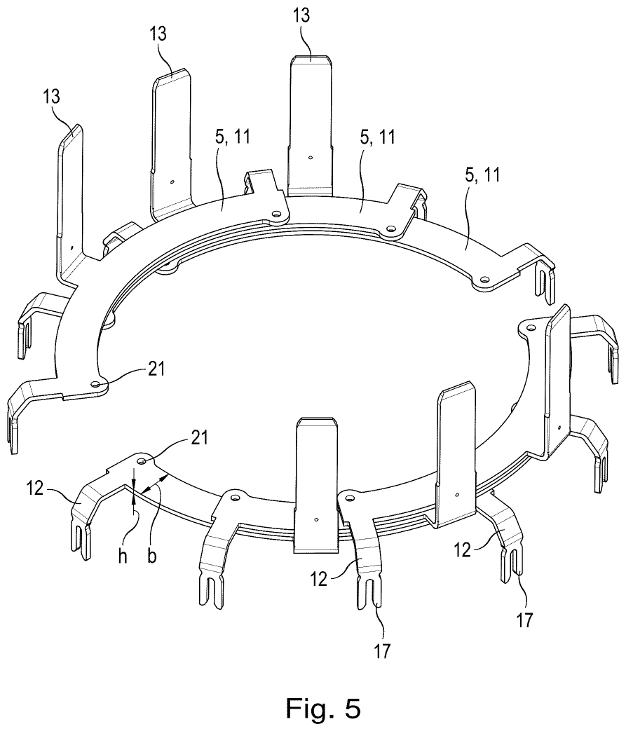

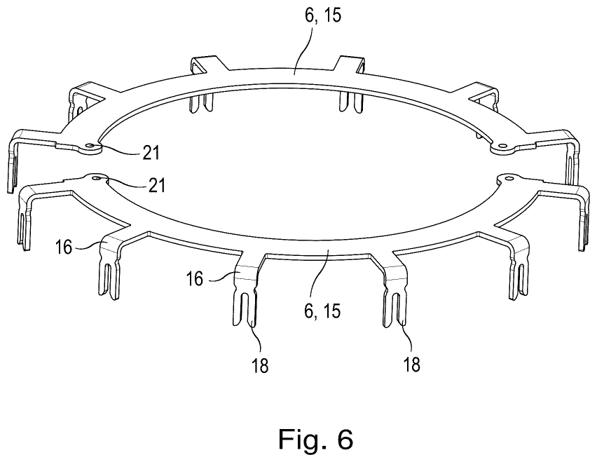

The electric motor 1 comprises a total of twelve coils 3, wherein six coils 3 are each assigned to a sub-segment 22 of the switching ring 2. Two coils 3 each form a phase, so that six coils 3 form a three-phase half motor, so to speak. The two coils 3 of a phase are connected by means of phase conductor tracks 5, compare FIG. 4 and FIG. 5, of which only the contact ends 12 and the connection tabs 13 are visible in FIG. 2. In addition, all six coils 3 of a sub-segment 22 are connected by neutral point conductor tracks 6 to implement a star connection, compare FIG. 4 and FIG. 6, wherein only the contact ends 16 of the neutral point conductor tracks 6 are visible in FIG. 2.

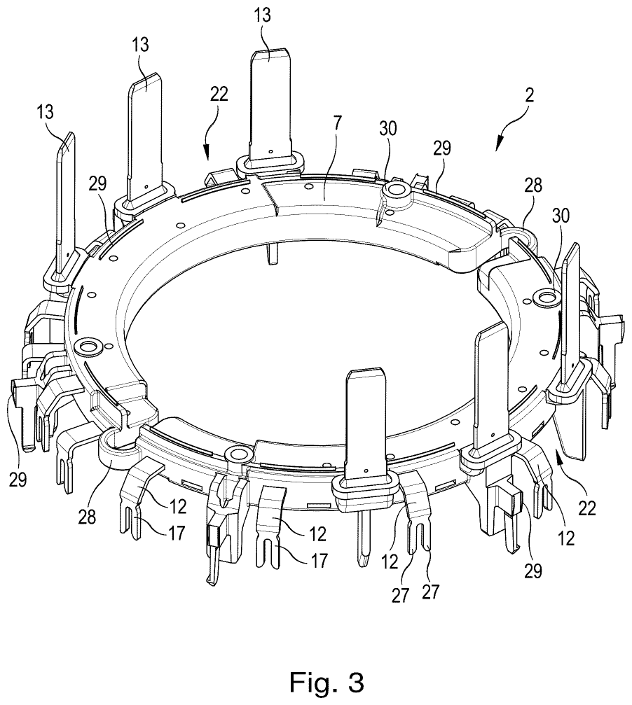

FIG. 2 also shows, see also FIG. 3 and FIG. 4, the switching ring 2 placed on the stator 10. The contact ends 12 of the phase conductor tracks 5 are in contact with the phase wire ends 14 of the coils 3, and the contact ends 16 of the neutral point conductor tracks 6 are in contact with the neutral point wire ends 19 of the coils 3. The contact ends 12, 16 comprise downwardly open fork-shaped elements 17, 18 which surround the phase wire ends 14, 19 of the coils 3. It is clearly visible that the opening between the fork bodies 27, shown in FIG. 3, of the fork-shaped elements 17, 18 extends in the axial direction. This ensures that the switching ring 2 is pluggable onto the stator 10 in the axial direction.

FIG. 3 shows the switching ring 2 according to the invention from FIG. 2. The two arcuate sub-segments 22, which are connected to each other via two elastic connecting elements 28, are clearly visible. Of the overmolded conductor tracks 5, 6, only the contact ends 12, 16 and the connection tabs 13 are visible. The base sections 11, 15 are completely overmolded together with the plastic part 23 and are therefore not visible in FIG. 3. The connection tabs 13 of the phase conductor tracks 5 protrude radially beyond the base section 11 and extend axially upward from the base section 11 according to FIG. 3. The contact ends 12, 16 of the phase conductor tracks 5 and the neutral point conductor tracks 6 also protrude radially outwards beyond the respective base section 11, 15 and extend in the axial direction, but downwards. The fork-shaped elements 17, 18 of the contact ends 12, 16, each with two fork bodies 27 and a space between the fork bodies 27, are also clearly visible.

Ridges 29 are formed on switching ring 2 both on the upper side and radially distributed around the circumference. When electric motor 1 is assembled, ridges 29 engage with the housing 24 of electric motor 1 and with the bearing shield 25 mounted axially from above on switching ring 2. Since the ridges 29 engage with the housing 24 and the bearing shield 25, vibration is prevented or reduced. The thickness of the ridges 29 decreases towards the outside and upwards, and the ridges 29 can therefore be easily engaged with the housing 24 and the bearing shield 25. The ridges 29 are deformed by the engagement with the housing 24 and the bearing shield 25. Since the thickness of the ridges 29 decreases towards the outside and upwards, the ridges 29 can easily deform when they are brought into engagement with the housing 24 or the bearing shield 25. This holds the switching ring 2 firmly in the housing 24 and achieves good vibration reduction. Furthermore, the switching ring 2 comprises circular projections 30 distributed around its circumference. When the electric motor 1 is assembled, i.e., when the bearing shield 25 is attached to the housing body 24, the circular projections 30 of the switching ring 2 are in contact with the inside of the bearing shield 25. This enables additional centering of the switching ring 2 on the bearing shield 25 and reduces vibrations.

FIG. 4 shows the phase conductor tracks 5 and the neutral point conductor track 6 of a sub-segment 22 of the embodiment without the holding element 7 positioning the conductor tracks 5, 6 according to FIG. 3 and the six coils 3 assigned to the sub-segment 22. The axial offset of the conductor tracks 5, 6 relative to each other is clearly visible. The upper three conductor tracks 5 are the phase conductor tracks 5, which are designed as identical parts, whose connection tabs 13 extend axially upward. In the present embodiment of the invention, the axial offset at the contact ends 12 of the phase conductor tracks 5 is compensated for by a corresponding axial offset of the phase wire ends 14 of the coils 3. The fork-shaped contact ends 17, 18 largely surround the wire ends 14, 19 of the coils 3. The lowest conductor track 6 is the neutral point conductor track 6, which connects all six coils 3 to each other.

To illustrate the arrangement of conductor tracks 5 and 6 in relation to the coils 3 of a half motor, FIG. 4 shows only the three phase conductor tracks 5.1 to 5.3, the corresponding contact ends 12.1 to 12.3, and the six coils 3.1 to 3.6. The uppermost phase conductor track 5.1 connects the coils 3.1 and 3.4 with the contact ends 12.1, whereby the coils 3.1 and 3.4 form one phase. Similarly, phase conductor track 5.2 connects coils 3.2 and 3.5 with contact ends 12.2, thus forming another phase. Similarly, phase conductor track 5.3 with contact ends 12.3 connects the two coils 3.3 and 3.6, so that coils 3.3 and 3.6 form a third phase. To implement a star connection, neutral point conductor track 6 with the six contact ends 16 connects all six coils 3.1 to 3.6 to each other.

FIG. 4 and FIG. 3 illustrate particularly well that each sub-segment 22 forms a three-phase half motor, wherein the two sub-segments 22 are identically constructed. The two half motors can be combined into one motor 1 by means of suitable control. The advantage of using two half motors is that motor 1 can also be operated by only one of the sub-segments 22 (at least in emergency mode), so that the use of sub-segments creates a redundant structure and thus increased operational reliability.

The embodiment of the switching ring 2 and, in particular, the embodiment of the fork-shaped contact ends 17, 18 of the phase conductor tracks 5 and the neutral point conductor track 6 allow the switching ring 2 to be pluggable in the axial direction. The space between the fork bodies 27 of the fork-shaped contact ends 17, 18 is designed so that the contact ends 17, 18 are brought into contact with the wire ends 14, 19 of the coils 3, whereby the plugging process is at least part of the contacting process.

FIG. 5 shows the six phase conductor tracks 5 of the embodiment, which are designed as identical parts. The base sections 11 are essentially designed as circular ring sections. They also each have two positioning recesses 21, which interact with corresponding positioning pins 20 for positioning in the holding device 7. It is also clearly visible that the base sections 11 are significantly wider than they are high, wherein the ratio of height h to width b is approximately 0.12. Due to the manufacture of the phase conductor tracks 5 using a punch-bending technique, the contact ends 12 and the connection tabs 13 also comprise the height h of the base section 11 in at least one dimension. The phase conductor track 5 is punched from a sheet metal as a quasi-two-dimensional part, and the contact ends 12 and the connection tabs 13 are bent in a further step.

The phase conductor tracks 5 are arranged rotated about the circular arc axis lying coaxially with the motor axis ax, so that the base sections 11 of all phase conductor tracks 5 lie on a circular ring with the width b of the base sections 11 and wherein the base sections 11 partially overlap in the circumferential direction. The base sections 11 of the three phase conductor tracks 5 assigned to each sub-segment 22 extend over slightly less than 180°. In the present embodiment, the base sections 11 of two phase conductor tracks 5 overlap in the circumferential direction over more than 50% of the circumferential extension of a sub-segment 22. In the center of each of the sub-segments 22, the base sections 11 of all three phase conductor tracks 5 even overlap. The extent of the overlap depends on the arrangement of the coils 3 and is limited by the connection tabs 13 extending upward in the direction parallel to the axis and the contact ends 12 extending downward in the direction parallel to the axis.

FIG. 6 shows the two neutral point conductor tracks 6, which are designed as identical parts in this embodiment. The circular arc-shaped base sections 15 each extend over slightly less than 180°. The width and height of the base section are identical to the base sections 11 of the phase conductor tracks 5. The base sections 15 of the neutral point conductor tracks 6 are arranged on the same circular ring as the base sections 11 of the phase conductor tracks 5. The contact ends 16, which protrude radially beyond the base section 15 and extend downwards in the axial direction, are also clearly visible.

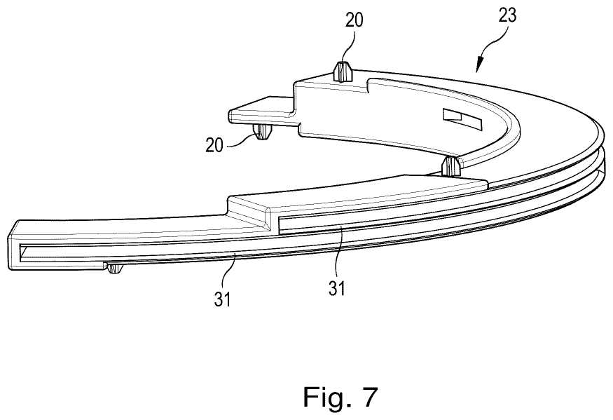

FIG. 7 shows the prefabricated plastic part 23 with the axially offset receiving elements for the conductor tracks 5, 6 in the form of pockets 31, wherein the lowest and uppermost of said pockets 31 each comprise two positioning pins 20 which interact with corresponding positioning recesses 21 in the conductor tracks 5, 6. For easier assembly, the positioning pins 20 also comprise flexible ribs and are tapered. The two middle pockets are closed axially from top and bottom, so that the conductor tracks 5, 6 are inserted into the pockets from a radial direction and are positioned by the corresponding geometry of the pockets.

During the manufacture of the switching ring 2, a overmolding tool is equipped with the conductor tracks 4, i.e., with the phase conductor tracks 5 and the neutral point conductor track 6, whereby the conductor tracks 4 are positioned relative to each other. In a further step, the conductor tracks 5, 6 are bent. The bending of all or at least one conductor track 5, 6 can be carried out completely or at least partially after the overmolding tool has been loaded. The conductor tracks 5, 6 are overmolded except for connection areas, in particular the contact ends 12, 16 and connection tabs 13, and, if necessary, except for tool contact areas. The overmolding allows the embodiment of the switching ring 2 shown in FIG. 3 to be produced.

### REFERENCE LIST

1 Electric motor
2 Switching ring
3 Coil
4 Conductor tracks
5 Phase conductor tracks
6 Neutral point conductor track
7 Holding device
8 Rotor
9 Rotor shaft
10 Stator
11 Base section of the phase conductor tracks
12 Contact ends of the phase conductor tracks
13 Connection tabs
14 Phase wire ends of the coils
15 Base section of the neutral point conductor track
16 Contact ends of the neutral point conductor track
17 Fork-shaped elements of the contact ends of the phase conductor tracks
18 Fork-shaped elements of the contact ends of the neutral point conductor tracks
19 Neutral point wire ends of the coils
20 Positioning pins
21 Positioning recess
22 Sub-segment
23 Prefabricated plastic part
24 Electric motor housing
25 Bearing shield
26 Lead-throughs
27 Fork body
28 Connecting element
29 Ridges
30 Circular projections
31 Pocket
h Height of the cross-sectional area of the base section of the phase conductor tracks
b Width of the cross-sectional area of the base section of the phase conductor tracks
ax Axial direction, motor axis
rad Radial direction

1. A switching ring for a multiphase electric motor which comprises at least two coils per phase for generating magnetic fields, wherein the switching ring comprises conductor tracks of the busbar type for contacting the coils, wherein the conductor tracks comprise phase conductor tracks and each of the phase conductor tracks is designed to contact the coils of one phase, and wherein the phase conductor tracks are positioned relative to one another and insulated from one another, and wherein the switching ring is attachable to the stator of the electric motor for contacting the coils, characterized in that the phase conductor tracks of the switching ring are designed as identical parts.

2. The switching ring according to claim 1, wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller.

3. The switching ring according to claim 1, wherein the switching ring comprises a neutral point conductor track which is configured to connect coils to each other for the implementation of a star connection, wherein the neutral point conductor track comprises a base section which is essentially formed as a circular ring section, and wherein the neutral point conductor track comprises contact ends that extend in the axial direction from the base section and are configured to be brought into contact with the neutral point wire ends of the coils.

4. The switching ring according to claim 2, wherein the base section of the phase conductor tracks comprises a cross-sectional area, wherein the cross-sectional area has a height and a width, wherein the height of the cross-sectional area is defined in the axial direction of the circular ring section and the width of the cross-sectional area is defined in the radial direction of the circular ring section, wherein the ratio of the height to the width is less than 1, preferably less than 0.5, and particularly preferably at most 0.2.

5. The switching ring according to claim 1,
wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller, and
wherein the switching ring comprises a neutral point conductor track which is configured to connect coils to each other for the implementation of a star connection, wherein the neutral point conductor track comprises a base section which is essentially formed as a circular ring section, and wherein the neutral point conductor track comprises contact ends that extend in the axial direction from the base section and are configured to be brought into contact with the neutral point wire ends of the coils, and
wherein the contact ends of the phase conductor tracks protrude radially beyond the base section and comprise fork-shaped elements, wherein the fork-shaped elements are configured to surround at least part of the phase wire ends of the coils and/or that the contact ends of the neutral conductor track protrude radially beyond the base section and comprise fork-shaped elements, wherein the fork-shaped elements are configured to surround at least part of the neutral wire ends of the coils.

6. The switching ring according to claim 1,
wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller, and
wherein the switching ring comprises a neutral point conductor track which is configured to connect coils to each other for the implementation of a star connection, wherein the neutral point conductor track comprises a base section which is essentially formed as a circular ring section, and wherein the neutral point conductor track comprises contact ends that extend in the axial direction from the base section and are configured to be brought into contact with the neutral point wire ends of the coils, and
wherein the contact ends of the phase conductor tracks and the contact ends of the neutral point conductor track are axially movable onto the corresponding wire ends of the coils relative to the motor axis, wherein the switching ring is pluggable onto the stator essentially in the axial direction, and wherein the plugging process is at least part of the contacting process.

7. The switching ring according to claim 1,
wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller, and
wherein the circular arc axes of the base sections of the phase conductor tracks, which are designed as circular ring sections, are essentially coaxial with each other.

8. The switching ring according to claim 1,
wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller, and
wherein the phase conductor tracks are arranged rotated about their circular arc axis and in that the phase conductor tracks are arranged axially offset relative to one another and partially overlap in the circumferential direction.

9. The switching ring according to claim 1,
wherein the phase conductor tracks comprise a base section that is essentially designed as a circular ring section and comprise contact ends, wherein the contact ends extend in the axial direction from the base section and are configured to be brought into contact with phase wire ends of the coils, and wherein the phase conductor tracks each have a connection tab for contacting a phase controller, and
wherein the switching ring comprises a neutral point conductor track which is configured to connect coils to each other for the implementation of a star connection, wherein the neutral point conductor track comprises a base section which is essentially formed as a circular ring section, and wherein the neutral point conductor track comprises contact ends that extend in the axial direction from the base section and are configured to be brought into contact with the neutral point wire ends of the coils, and
wherein that the neutral point conductor track is arranged axially offset to the phase conductor tracks and that the circular arc axis of the base section of the neutral point conductor track, which is designed as a circular ring section, is arranged essentially parallel to the circular arc axes of the base sections of the phase conductor tracks and that the base section of the neutral point conductor track, seen from the axial direction, overlaps at least partially with the base sections of the phase conductor tracks, preferably overlapping by at least 50 %.

10. The switching ring according to claim 1, wherein the phase conductor tracks are elements manufactured using a punch-bending technique.

11. The switching ring according to claim 1, wherein the switching ring comprises a holding device for positioning at least some of the conductor tracks relative to one another.

12. The switching ring according to claim 1, wherein the switching ring comprises sub-segments for creating redundancy for fail-safe operation of the electric motor, each of the sub-segments comprising conductor tracks of the busbar type for contacting the coils, the conductor tracks comprising phase conductor tracks, and each of the phase conductor tracks being configured to contact the coils of one phase, and wherein phase conductor tracks are positioned relative to one another and insulated from one another, and wherein the sub-segments are pluggable onto the stator of the electric motor for contacting the coils, and wherein the phase conductor tracks of the sub-segments are designed as identical parts.

13. The switching ring according to claim 12, wherein the conductor tracks of a sub-segment comprise a neutral point conductor track and the neutral point conductor tracks of the sub-segments are designed as identical parts.

14. A multiphase electric motor with a rotor, a stator, and coils for generating magnetic fields, wherein the electric motor comprises a switching ring according to claim 1.

15. A method for manufacturing a switching ring, in particular a switching ring according to claim 1, comprising the following method steps:
equipping a overmolding tool with conductor tracks in such a way that the conductor tracks are brought into the position intended for the finished switching ring
overmolding the conductor tracks except for connection areas, in particular the contact ends and connection tabs for connecting the coils, and, if necessary, except for tool contact areas.
